(19) United States
(12) Patent Application Publication
(10) Pub. No.: US 2016/0223140 A1
(43) Pub. Date: Aug. 4, 2016

(54) A Tank-Pump Integrated Structure for LNG Filling Station

(71) Applicant: SHIJIAZHUANG ENRIC GAS EQUIPMENT CO., LTD, Hebei (CN)

(72) Inventors: Wukai WANG, Shijiazhuang (CN); Lanhui ZHAI, Shijiazhuang (CN); Hongxia WANG, Shijiazhuang (CN); Lixia WEI, Shijiazhuang (CN); Chunjuan WANG, Shijiazhuang (CN); Jian ZHANG, Shijiazhuang (CN); Huaqin BAI, Shijiazhuang (CN)

(21) Appl. No.: 14/899,697

(22) PCT Filed: Feb. 26, 2014
(86) PCT No.: PCT/CN2014/072548

§ 371 Date: Dec. 18, 2015

(30) Foreign Application Priority Data
Oct. 23, 2013 (CN) 201320654627.X

(51) Int. Cl. F17C 3/04

(52) U.S. Cl. CPC F17C 3/04; F17C 2203/0304; F17C 2203/0629; F17C 2205/0326; F17C 2221/033; F17C 2223/0161; F17C 2223/046; F17C 2227/0142; F17C 2227/0178; F17C 2260/035; F17C 2270/0139

(57) ABSTRACT

Disclosed herein is a tank-pump integrated structure for an LNG filling station, which comprises a tank body having heat insulation layer space, a siphon package at the bottom of the tank body and a pump sump arranged in the siphon package. Moreover, a first heat insulation pipeline in the siphon package is connected to an LNG inlet on the pump sump, and a gas return port of the pump sump is coupled with the tank body by means of a second heat insulation pipeline. An on-off valve is arranged on the first heat insulation pipeline between the tank body and the pump sump, a shut-off valve is additionally arranged on the second heat insulation pipeline between the gas return inlet and the tank body, and heat insulation devices are provided external to the on-off valve and the shut-off valve respectively. The integrated structure can reduce investment costs, shorten the construction period, and facilitate maintenance of the submersible pump via the valves.

### FIELD OF THE INVENTION

The present invention is directed to improvements on LNG filling station equipment, which generally relates to improvements on a connecting structure between the storage tank and a liquid-filling pump, and thereof used in an LNG filling station, and more particularly, a tank-pump integrated structure in the LNG filling station.

### BACKGROUND

An LNG filling station uses cryogenic submersible pumps to fuel the liquefied natural gas (LNG) automobiles. Usually an LNG storage tank and a submersible pump sump are independently arranged and then interconnected, and as a result, it takes a long period of time to establish an LNG station. Moreover, the LNG pipelines require independent heat insulation protection, resulting in high construction costs.

The Chinese patent application (Application No. 201320065885.4) discloses an energy-efficient vertical cryogenic storage tank. The storage tank comprises a siphon package arranged at the bottom of the tank body and a heat insulation bin matched with the siphon package, wherein a submersible pump is placed in the heat insulation bin, and the heat insulation bin works as an equivalent of a submersible pump sump. But this structure has no valve arranged on the liquid inlet pipelines of the storage tank and the submersible pump sump, nor on a gas return pipeline. When the submersible pump needs to be maintained, liquid in the storage tank needs to be emptied so that the submersible pump can be taken out from the heat insulation bin, which is time-consuming and labor-intensive, making it difficult to dismantle and maintain and thus impractical to use. Therefore, there is an urgent need for a new structure that can not only save investment costs but also allow for individual maintenance of the submersible pump.

### SUMMARY OF THE INVENTION

The presently disclosed embodiments are directed to solving issues relating to one or more of the problems presented in the prior art, as well as providing additional features that will become readily apparent by reference to the following detailed description when taken in conjunction with the accompanying drawings.

The present invention discloses a tank-pump integrated structure for an LNG filling station, which is designed to reduce construction time and costs and facilitate the maintenance of the submersible pump. According to embodiments of the invention, the submersible pump sump and the storage tank are integrally assembled and manufactured; pipelines and the pump sump are formed in a cold insulation sandwich structure integrated with the storage tank, and yet valves adopt an individual external-wrapping cold insulation layer structure. With such a structure, investment costs can be reduced, construction periods can be shortened, and the maintenance of the submersible pump can be facilitated.

According to one embodiment of the present invention, a tank-pump integrated structure for an LNG filling station comprises a tank body having heat insulation layer space, a siphon package at the bottom of the tank body and a pump sump arranged in the siphon package, wherein a first heat insulation pipeline in the siphon package is connected to an LNG inlet on the pump sump, and a gas return port of the pump sump is coupled with the tank body by means of a second heat insulation pipeline, and wherein an on-off valve is additionally arranged on the first heat insulation pipeline between the tank body and the pump sump, a shut-off valve is additionally arranged on the second heat insulation pipeline between the gas return port and the tank body, and heat insulation devices are provided external to the on-off valve and the shut-off valve, respectively.

The present invention provides a few advantages as follows: 1. by having the submersible pump sump arranged at the bottom of the storage tank and integrally assembled and manufactured with the storage tank, the heat insulation layers of the pipelines a, b and the siphon package as well as the pump sump formed in a cold insulation layer structure integrated with the storage tank, the present invention improves the configuration of a conventional construction, which has an individual structure built at one side of the storage tank, thereby shortening the connecting pipelines, achieving a good cold insulation effect and saving construction time and costs. 2. By having additional valves arranged on the pipelines a and b, this can not only keep the previous benefits of having the entire apparatus work, but also overcome the drawback of having to empty the tank to maintain the submersible pump. The apparatus according to the present invention can isolate the pump sump from the tank body at any time so as to block passages of cryogenic liquid or returning gas, thereby allowing for maintenance of the submersible pump at any time. In addition, an individual external-wrapping heat insulation layer structure is adopted for existing valves, which are dismantled during maintenance, to enable a temperature recovery of the submersible pump, thus making maintenance convenient and safe.

Further features and advantages of the present disclosure, as well as the structure and operation of various embodiments of the present disclosure, are described in detail below with reference to the accompanying drawings.

### BRIEF DESCRIPTION OF THE DRAWINGS

The present disclosure, in accordance with one or more various embodiments, is described in detail with reference to the following figures. The drawings are provided for purposes of illustration only and merely depict exemplary embodiments of the disclosure. These drawings are provided to facilitate the reader's understanding of the disclosure and should not be considered limiting of the breadth, scope, or applicability of the disclosure. It should be noted that for clarity and ease of illustration these drawings are not necessarily made to scale.

FIG. 1 is a structural schematic diagram according to embodiments of the present invention;

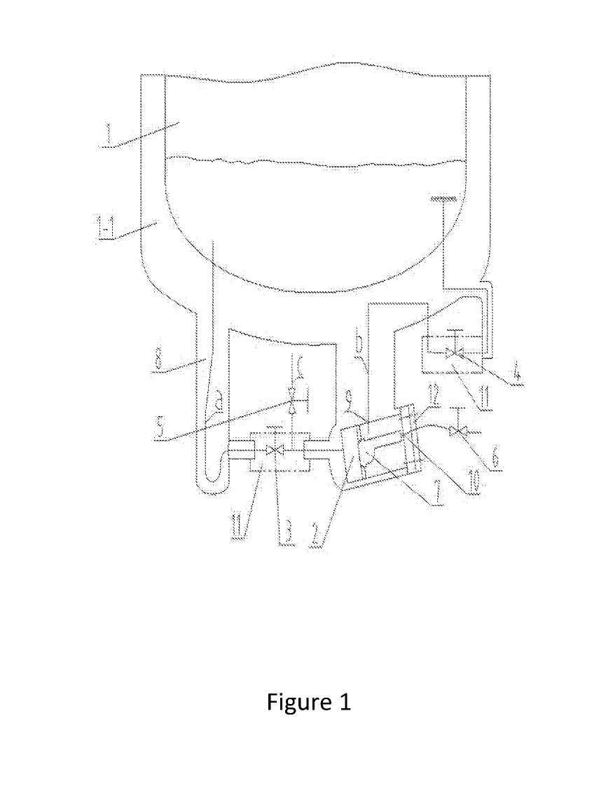

In FIG. 1, 1 represents a tank body, 1-1 represents heat insulation layer space, 2 represents a pump sump, 3 represents an on-off valve, 4 represents a shut-off valve, 5 represents a liquid filling valve, 6 represents a liquid charging valve, 7 represents a submersible pump, 8 represents a siphon package, 9 represents a gas return port, 10 represents a liquid outlet, 11 represents heat insulation devices, a represents a first heat insulation pipeline, b represents a second heat insulation pipeline, and c represents a third heat insulation pipeline.

### DETAILED DESCRIPTION OF EXEMPLARY EMBODIMENTS

The following description is presented to enable a person of ordinary skill in the art to make and use the invention. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the invention. Thus, embodiments of the present invention are not intended to be limited to the examples described herein and shown, but is to be accorded the scope consistent with the claims.

As shown in FIG. 1, a tank-pump integrated structure for an LNG filling station comprises a tank body 1 having heat insulation layer space 1-1, a siphon package 8 at the bottom of the tank body and a pump sump 2 arranged in the siphon package. Further, a first heat insulation pipeline a in the siphon package 8 is connected to an LNG inlet on the pump sump 2, and a gas return port 9 of the pump sump 2 is coupled with the tank body 1 by means of a second heat insulation pipeline b. Importantly, an on-off valve 3 is additionally arranged on the first heat insulation pipeline a between the tank body 1 and the pump sump 2, and a shut-off valve 4 is additionally arranged on the second heat insulation pipeline b between the gas return port 9 and the tank body 1, wherein heat insulation devices 11 are provided external to the on-off valve 3 and the shut-off valve 4, respectively.

A third heat insulation pipeline c is provided on the first heat insulation pipeline a and between the shut-off valve 4 and the pump sump 2. Additionally, a liquid filling valve 5 is arranged for the pipeline c. A liquid outlet 10 of a submersible pump 7 in the pump sump 2 is connected to an LNG dispensing vessel by means of a liquid charging valve 6.

In order to facilitate the removal of the submersible pump for maintenance, an access door 12 with a heat insulation sandwich structure is arranged on the pump sump 2.

In one embodiment, as shown in FIG. 1, the pump sump 2 is arranged at the bottom of a bottom head of the tank body 1, and as an ancillary attachment in the storage tank, the pump sump is integrally assembled and manufactured with the storage tank. After connecting the pipelines, the heat insulation layer space 1-1 of the tank body 1, the pump sump 2, and heat insulation sandwich layers of pipelines a, b are integrated for heat insulation and cold insulation; and then the on-off valve 3 and the shut-off valve 4 are covered with heat insulation devices 11. When the submersible pump 7 needs to be maintained, the on-off valve 3, the shut-off valve 4, the liquid filling valve 5 and the liquid charging valve 6 are closed so as to block cryogenic liquid from entering into the pump sump 2. Also, the heat insulation devices 11 of the on-off valve 3 and the shut-off valve 4 are removed. After the submersible pump 7 is heated and the access door 12 is opened, the submersible pump 7 is taken out from the pump sump 2 for maintenance. This way allows the submersible pump 7 to be dismantled for maintenance when the tank body 1 contains liquid.

What is claimed is:

1. A tank-pump integrated structure for an LNG filling station, comprising:
a tank body (1) having heat insulation layer space (1-1);
a siphon package (8) at the bottom of the tank body; and
a pump sump (2) arranged in the siphon package,
wherein a first heat insulation pipeline (a) in the siphon package (8) is connected to an LNG inlet on the pump sump (2), and a gas return port (9) of the pump sump (2) is coupled with the tank body (1) by means of a second heat insulation pipeline (b), and
wherein an on-off valve (3) is arranged on the first heat insulation pipeline (a) between the tank body (1) and the pump sump (2), a shut-off valve (4) is arranged on the second heat insulation pipeline (b) between the gas return port (9) and the tank body (1), and heat insulation devices (11) are provided external to the on-off valve (3) and the shut-off valve (4), respectively.

2. The tank-pump integrated structure for the LNG filling station of claim 1, wherein a third heat insulation pipeline (c) is positioned on the first heat insulation pipeline (a) and between the shut-off valve (4) and the pump sump (2), and a liquid filling valve (5) is arranged in connection with the third heat insulation pipeline (c).

3. The tank-pump integrated structure for the LNG filling station of claim 1, wherein a liquid outlet (10) of a submersible pump (7) in the pump sump (2) is connected to an LNG dispensing vessel by means of a liquid charging valve (6).

4. The tank-pump integrated structure for the LNG filling station of claim 1, wherein an access door (12) with a heat insulation sandwich structure is arranged on the pump sump (2).
